(19) United States
(12) Patent Application Publication
(10) Pub. No.: US 2019/0244613 A1
(43) Pub. Date: Aug. 8, 2019

(54) VoIP Cloud-Based Virtual Digital Assistant Using Voice Commands

(71) Applicant: Net2Phone, Inc., Newark, NJ (US)

(72) Inventors: Samuel Joshua Jonas, Englewood, NJ (US); Simon Malcolm Ritholtz, Woodmere, NJ (US); Nathaniel Ernest Ritholtz, Inwood, NJ (US); Stephen Ernest Gulics, Colonia, NJ (US); Elena Marie Papavero, New Egypt, NJ (US); Anthony S. Davidson, Tuxedo, NY (US); Geoffrey Michael Herney, Milford, PA (US); William Joseph Shankle, Jackson, NJ (US); Jeffrey S. Skelton, Millstone Township, NJ (US)

(73) Assignee: Net2Phone, Inc., Newark, NJ (US)

(21) Appl. No.: 16/265,487

(22) Filed: Feb. 1, 2019

Related U.S. Application Data
(60) Provisional application No. 62/627,529, filed on Feb. 7, 2018.

(51) Int. Cl. G10L 15/22; H04M 7/00; G10L 15/30

(52) U.S. Cl. CPC G10L 15/22; H04M 7/006; H04L 63/0428; G10L 2015/223; G10L 15/30

(57) ABSTRACT

A VoIP server may provide voice-based services when a VoIP device dials a preconfigured number (e.g., “##999”). Similarly, a VoIP device having an additional display and/or function keys may signal that a voice-command communications channel should be opened between the VoIP device and the VoIP server in a different way (e.g., using a dedicated button). The VoIP server recognizes the number being called as a request for voice-based services as it would recognize a call to a voicemail extension as a request for voicemail services. Thus, the VoIP server intercepts the outgoing call and directs the call to itself to begin providing voice-based services (e.g., voice dialing and calendaring services).

### CROSS-REFERENCE TO RELATED APPLICATION

This application is based upon and claims the benefit of priority from U.S. Provisional Patent Application No. 62/627,529, filed on Feb. 7, 2018; the entire contents of which are incorporated herein by reference.

### FIELD OF INVENTION

The present invention is directed to a method and system for utilizing voice control in a telephony system, and, in one embodiment, to a Voice over Internet Protocol (VoIP) cloud-based virtual digital assistant that can be accessed (e.g., using a dialed extension, feature code or button from a VoIP phone or using a GUI on a web-portal based VoIP device) in which the virtual digital assistant can be controlled by voice commands.

### DISCUSSION OF THE BACKGROUND

Existing VoIP systems, such as a system shown in FIG. 1, can allow a number of different Voice over IP (VoIP) communications devices (120/130/140) to connect to a VoIP server 160 to communicate with other VoIP devices (not shown) as well as telephone devices connected to the public switched telephone network (PSTN) and mobile telephone devices connected via cellular networks. In general, the communications network 110 between the VoIP devices (120/130/140) and the VoIP server 160 is depicted as a cloud. The communications network 110 can be an internal network (e.g., within a company such that the VoIP server 160 is acting as a private branch exchange (PBX)) or an external network (e.g., the Internet) such that the VoIP devices (120/130/140) and the VoIP server 160 can be remotely located from each other. As shown in FIG. 1, exemplary VoIP devices include a digital interface 120 (e.g., an external box) connected to a traditional PSTN (analog) phone such that the digital interface 120 performs the necessary conversion of voice signals to and from the analog telephone which are routed from/to the VoIP server 160 along with information on any key presses (or DTMF tones) generated by the analog telephone. The digital interface 120 also performs the necessary communication with the VoIP server 160 to configure and/or authenticate the digital interface 120 so that the digital interface 120 can be communicated with by devices trying to reach the user of the analog telephone associated with the digital interface 120. This digital interface 120 need not even have a display such that it is just an external box having a connection for the analog telephone and an interface (wired or wireless) to the digital network (e.g., a WiFi connection or an Ethernet connection). In non-battery powered digital interfaces, the digital interface may also include an AC or DC power supply.

In addition, a digital telephone 130 is depicted in which the functions of the analog telephone and the digital interface 120 are integrated into a single device. Similarly, digital telephone 140 includes support for a display (e.g., internal or external display) and/or function keys such that enhanced functions (e.g., phone number look up, redial, call forwarding, and call bridging) can be performed.

Each of the VoIP devices (120/130/140) can utilize the basic voice services (e.g., dialing, call switching, hang-up) of the VoIP server 160. In addition, the VoIP server 160 may provide additional services (e.g., telephone look up services) to phones (e.g., digital phone 140) that support those functions. Similarly, the VoIP server 160 may provide, on a device-by-device basis, voicemail services (e.g., based on whether the corresponding user has requested that service as part of his/her subscription). In one embodiment, voicemail (VM) services are provided by a user calling a predefined number (e.g., ‘#99’) and using DTMF tones to interact with the VM service. In a second embodiment, the function keys associated with a digital phone 140 are used instead to provide the voicemail services (e.g., erasing voicemails, fast forwarding, replaying, and skipping).

### BRIEF DESCRIPTION OF THE DRAWINGS

The following description, given with respect to the attached drawings, may be better understood with reference to the non-limiting examples of the drawings, wherein:

FIG. 1 is block diagram of a known Voice over IP (VoIP) configuration in which a number of VoIP devices are capable of interacting with a VoIP server;

FIG. 2 is block diagram of a cloud-based VoIP configuration in which a number of VoIP devices are capable of interacting with a VoIP server to utilize voice commands processed by a speech recognition platform to control at least one function controllable using the VoIP server;

FIG. 3 is block diagram of a cloud-based VoIP configuration in which a number of VoIP devices are capable of interacting with a VoIP server to utilize voice commands processed by a speech recognition platform and confirmed to be from a known user by a voice recognition platform to control at least one function controllable using the VoIP server;

FIG. 4 is block diagram of a cloud-based VoIP configuration in which a number of VoIP devices are capable of interacting with a VoIP server to utilize voice commands processed by a speech recognition platform and confirmed by a voice recognition platform to control telephone bridging services controllable using the VoIP server; and

FIG. 5 is block diagram of a cloud-based VoIP configuration in which a number of VoIP devices are capable of interacting with a VoIP server to utilize voice commands processed by a speech recognition platform and utilizing services external to the voice server.

### DISCUSSION OF THE PREFERRED EMBODIMENTS

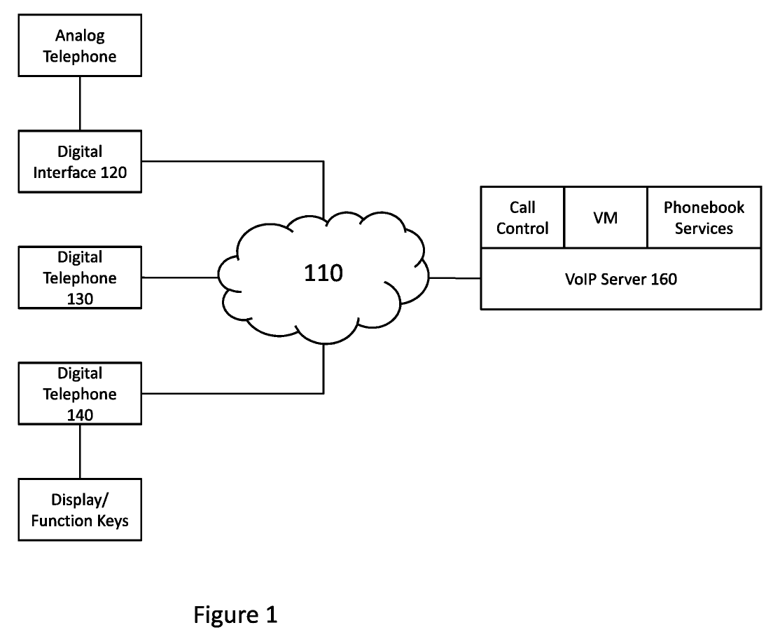

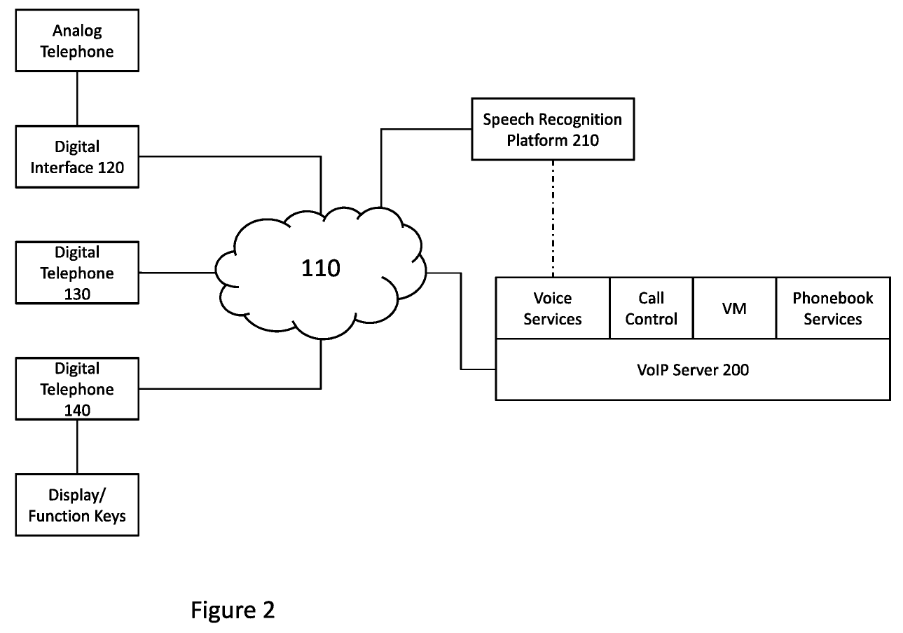

Turning to FIG. 2, the VoIP server 160 of FIG. 1 has been replaced by an enhanced VoIP server 200 (e.g., including special-purpose hardware and/or software) for enabling a user of a conventional VoIP device (120/130/140) to receive enhanced services. In addition, digital telephone 130 and digital telephone 140 may include VoIP devices that are virtual telephones such as would be provided by an “app” (e.g., an IOS “app” or an Android “app”) on a portable device (e.g., tablet or phone) or using a microphone and speaker (wired or wirelessly) attached to a computer running special purpose software (e.g., using a stand-alone application, a Java applet (either stand-alone or in a web browser) or an HTML5 interface of a web browser) to provide a graphical user interface that controls dialing and other enhanced functions (e.g., phone number look up, redial, call forwarding, and call bridging). The virtual telephones connect to the VoIP server 200 (and other service providers) similarly to the other VoIP devices described herein.

The VoIP server 200 may provide these services by the VoIP device dialing a preconfigured number (e.g., “##999”) or feature code (e.g., “*88”). (While the description below is provided with respect to a user dialing an extension, one of ordinary skill in the art will appreciate in devices (e.g., VoIP device 140) having an additional display and/or function keys, the VoIP device may signal that a voice-command communications channel should be opened between the VoIP device and the VoIP server 200 in a different way (e.g., using a dedicated button).)

An exemplary interaction is described with respect to FIG. 2, but those of ordinary skill in the art will understand that other interactions are possible. In a first step, the telephone of the VoIP device is taken “off-hook” (e.g., by lifting a handset or turning on a speakerphone). In a second step, a user of the VoIP device dials a preconfigured number (e.g., “##999”). (The first and second steps may be combined in a single step in those devices that automatically go off-hook when a prestored telephone number is selected (e.g., using a preprogrammed key).) The VoIP device recognizes that a call has been made and informs the VoIP server 200 to which is it configured to connect of the call attempt. The VoIP server 200 recognizes the number being called as a request for voice-based services as it would recognize a call to a voicemail extension as a request for voicemail services. Thus, the VoIP server 200 intercepts the outgoing call and directs the call to itself.

The VoIP server 200 then establishes a communication channel for communication with the voice device, and the channel is either encrypted or unencrypted. For example, the VoIP server 200 accepts a socket-based connection initiated by the voice device to a well-known port of the VoIP server 200. (In an embodiment in which the channel may include communications networks that are subject to eavesdropping, the channel may be established over an encrypted IP tunnel or a VPN or IPsec session.) The socket-based connection then prepares to pass digital voice data (e.g., using compressed speech (such as used by codecs including μ-law and a-law versions of G.711, G.722, iLBC, and/or G.729) or uncompressed speech) between the voice device and the VoIP server 200 either using a pre-established data protocol or a data protocol selected at the time the socket-based communication was established. Part of preparing to receive the voice data is making sure that a connection between the VoIP server 200 and a speech recognition platform 210 exists, and if one does not exist, creating one. The speech recognition platform 210 may be either a locally provided service (as depicted by the dashed line there between) or a remotely provided service (that may require encryption, as described above).

The voice services of the VoIP server 200 then pass at least a portion of the received voice signals to a speech recognition platform 210 so that the speech recognition platform 210 can detect the voice commands being provided by the telephone user. The amount of voice data that is transmitted depends on how the voice services are configured, and the configuration may be either system-wide or specific to a particular user or group of users. In general, two main configurations are possible. In the first main configuration, each set of programmed interactions is preceded by contacting the voice services platform, optionally receiving a greeting such as “Hello, how can I help you,” and followed by any interactions necessary to complete the user's desired action, at which point the user terminates the call with the voice services platform (e.g., by hitting a specified DTMF keypad key such as ‘#’ or by physically or virtually hanging up the phone). In the second main configuration, multiple programmed interactions can be performed on the same call to the voice services platform. In such a configuration, after a first set of interactions has been completed by a user, the user does not terminate the call with voice services but instead voice services goes into a “quiet mode” where the voice services platform listens for a next set of interactions to begin. In such a configuration, voice commands preferably are preceded by a known phrase (e.g., “Hey VoiceBot”) so that the system is sure that the user is addressing the VoIP server. The voice platform also may remind the user that it is going to continuing listening by playing a reminder message at the end of a series of voice interactions. For example, “Going to sleep now. Let me know if there is anything else I can do by saying ‘Hey Voicebot.’” Depending on the implementation, the command phrase need not be used before the first command after connecting to voice services as the beginning of an interaction is implied by calling voice services. Additional implementation details of how voice signals are collected and processed are provided below.

In a first embodiment, the voice services of the VoIP server 200 just pass along all voice signals from the user to the speech recognition platform 210 until the speech recognition platform 210 tells the voice services to stop. (In this and the other configurations described herein, the VoIP server 200 may also pass to the speech recognition platform the corresponding extension number or a unique transaction id or other identifier to identify the interaction as being associated with a known user or extension.) This is the simplest system for the VoIP server 200 to implement because it just acts as a pass through and does not require any additional voice or tone detection hardware or software or any timing hardware or software. It is up to the speech recognition platform 210 to determine when the command is finished (e.g., using silence detection or any of the other techniques described below).

In a number of other embodiments, the VoIP server 200 and/or voice device include(s) additional hardware or software to reduce the amount of voice data sent to the VoIP server 200 and/or the speech recognition platform 210 or to otherwise aid the VoIP server 200 and/or the speech recognition platform 210. In one such embodiment (referred to as the second embodiment), the VoIP server 200 limits the amount of voice that it will receive (and buffer or pass through) to a maximum of a fixed time. Thus, after the time limit (e.g., 10 seconds), the VoIP server 200 stops processing any voice signals over the voice connection and passes any buffered, untransmitted voice data to the speech recognition platform 210 so that the speech recognition platform 210 can process the voice data it received. (Any later-received voice data is flushed before a next command is processed.) Given that some voice commands may be long, such a fixed time limit may be undesirable.

In a third embodiment, the voice device includes either (1) button detection hardware and/or software (for detecting button presses on the telephone keypad or on the external display/function keys) or (2) DTMF detection hardware and/or software. In such configurations, the user indicates to the voice device that the user has finished speaking (by pressing a keypad key or a function key), and the voice device can then tell the VoIP server 200 that the voice signals have been delivered (e.g., either using an in-band or out-of-band communication). The VoIP server 200 then stops processing any voice signals over the voice connection and passes any buffered, untransmitted voice data to the speech recognition platform 210 so that the speech recognition platform 210 can process the voice data it received.

In a fourth embodiment, the voice device and/or the VoIP server 200 includes silence detection hardware and/or software for determining when there has been a sufficient period of silence after a user finished speaking to indicate that the user has indeed finished providing the voice command. In such configurations where the silence detection hardware and/or software is in the voice device, the voice device can then tell the VoIP server 200 that the voice signals have been delivered (e.g., either using an in-band or out-of-band communication). Otherwise, the VoIP server 200 can detect the silence itself. In either case, after detecting the silence threshold, the VoIP server 200 then stops processing any voice signals over the voice connection and passes any buffered, untransmitted voice data to the speech recognition platform 210 so that the speech recognition platform 210 can process the voice data it received.

After the speech recognition platform 210 processes the speech it received (in digitized audio form), the resulting text is processed depending on where the voice command services are provided. In a first configuration of voice command services, the voice command services are performed locally to the VoIP server environment (i.e., on one or more servers provisioned by the organization administering and/or provisioning the VoIP server). In such a configuration the processed text is sent from the speech recognition platform 210 back to the VoIP server as text for processing “locally.” The speech recognition platform 210 also may pass back the extension or unique identifier that it received when it received the voice signals.

In a second configuration of voice command services, the voice command services are provided remotely (e.g., by a third-party service provider providing physical and/or virtual hardware that implements the voice command services). In such a configuration, the voice command services will have to be provided with scripts or other coding required to implement the desired functionality. The remotely provided voice command services can either directly communicate with the speech recognition platform 210 or have all interactions between the voice command services and the speech recognition platform pass through the VoIP server. In either case, the voice command services preferably receive both the recognized text and the extension or unique identifier associated with the received text prior to processing the voice commands represented by the recognized text.

In general, with remotely provided voice command services, the VoIP server 200 receives back an audio file or audio stream of digital voice responses (e.g., “Which of these Smiths do you mean? There are two”; “I'm sorry, I didn't understand what you said”; or “On which of these days would you prefer to set up the meeting”) and/or DTMF signals from the remote voice command services platform, and the VoIP server 200 then passes on those digital voice responses to the VoIP device. (The VoIP server 200 optionally also may receive the text corresponding to the received audi file or audio stream as might be used for transaction logging, debugging or context/data analysis for future versions/features.) The VoIP server 200 also may receive from the voice command services control requests (e.g., for dialing a number or controlling a switch or bridge as described in greater detail below) or other data requests/queries whose results are necessary to complete the programmed processing (e.g., a query for the system time or user-specific or company-wide/server-specific information that is associated with the voice command being processed), preferably accompanied with the extension or unique identifier corresponding to the request(s).

Alternatively, databases and other configuration information described herein may be “pre-shared” with the platform providing the voice command services. In such a configuration, to reduce data sharing, the voice command services may be provided on a user-by-user basis (e.g., as separate “bots” or virtual machines). Alternatively, the data of more than one user may be provided to the same bot or virtual machine. In such a configuration, to avoid unintentional data spill over between users, the data that can be played back or otherwise utilized by the voice command services in responding to a voice command is programmed to be limited to data corresponding to the extension number (optionally coupled with a PIN or voice print) or unique id corresponding to the received voice. For example, a user requesting the system to call “Jane Smith” would only be provided entries in a phonebook corresponding to that user (or extension). However, data also can be shared (e.g., across an encrypted link) dynamically between the VoIP server and the remote voice command services such that the VoIP server only provides to the remote voice command services the user-specific data that corresponds to the voice command currently being processed (or to group- or company-specific data for groups and/or companies of which the user is a member).

Exemplary processing of the converted text of the received voice hereinafter will be described as though the voice command services are performed locally, but those of skill in the art will recognize that the description herein can be modified to provide the same functionality even if the voice command services are provided remotely. In addition, when the voice command services are provided locally, the speech recognition platform 210 may pass back, in addition to the converted text, if detected, other information about the text and/or received voice signals. For example, the speech recognition platform 210 may pass back a confidence indicator indicating how confident it is in the corresponding text.

The received text is then processed by the voice services software/hardware of the VoIP server 200 to determine what commands the user was trying to provide. While a number of commands are described below, those commands are to be understood to be exemplary, and other commands are possible given the present disclosure. Moreover, voice commands may be single commands or interactive commands where there are a series of commands given by a user, each with an optional response by the system. In the examples below, a short pause in the user's speech is given by an ellipsis (“ . . . ”).

A first exemplary command that the user may have provided is a self-contained command, such as “Hey VoiceBot . . . What time is it?” In such a case, after the voice signals are received from the voice device and processed by the speech recognition platform 210, the VoIP server 200 receives the resulting text string “what time is it”. The VoIP server 200 performs natural language processing on the resulting text string and determines that it corresponds to a request for the system time. The VoIP server 200 can then look up the system time (and user specific configuration information indicating a user's configured location) and utilize text-to-speech hardware/software to send the response (e.g., “it is noon, Eastern time”) over the open communications channel with the voice device.

Likewise, the VoIP server 200 may process the resulting text and realize that the command is for some other local service. For example, when the resulting text is “Check my voicemail”, the VoIP server 200 can interact with the voicemail services on the VoIP server 200 to determine if there are any voicemail messages that have not been listened to. If so, the system can announce the number of unplayed messages along with a question as to whether they should be played. For example, the VoIP server 200 could respond “You have two unplayed voicemail messages. Should I play them?” The voice services would then begin a new listening session to process the user's response. Thus, some voice services will require that the VoIP server 200 maintain state in order to complete the desired interaction with the user. If there are no unplayed voicemails, the system correspondingly can inform the user but offer to play old voicemails. The system can further listen during playback of voicemail messages for commands that control the playback, such as “skip,” “delete,” “replay,” “next,” and “pause.”

As another example, the VoIP server 200 may utilize voice commands to provide voice-based dialing. For example, the VoIP server 200 may receive the request “dial extension 1234” or “use an outside line to dial 973-555-1212” or “dial 973-555-1212”. In each of those cases, the VoIP server 200 can terminate its collection of voice signals and then utilize the call control services to complete the requested call, just as if it had received the number to be dialed from the voice device as the initial dialing sequence.

In a more complex interaction, the resulting text may indicate that the user is trying to dial by name instead. This requires a look-up using phonebook services, which can be a local service residing on the VoIP server 200 and/or using company-wide or server-wide information. (As is discussed in greater detail below, the lookup service also can utilize one or more external contact services as well.) In the phonebook services example, the user may provide the voice request “dial Zali”. The voice services may perform a phone number lookup using “Zali” as a first or last name, and only one match is found, the voice services announce the full name of the resulting match along with an indication that the person is being dialed. For example, “Dialing Zali Ritholtz.” If the requested name instead matched more than one result, an interactive process may begin to determine which name was intended (e.g., (a) the system prompts with full names and waits for a positive confirmation or (b) the system asks for more precision). A first exemplary narrowing is shown below.

| (User) | (System) |
|---|---|
| Call smith | |
| | Which of these Smiths do you mean? There |
| | are two. |
| | Jenny Smith? |
| No | |
| | Johhny Smith? |
| Yes. | |

Alternatively, where the speech recognition platform 210 indicates that the confidence for the name “Smith” is low, the system may utilize other names also that sound like Smith. For example, using the same kind of narrowing, a set of interaction would occur like the following.

| (User) | (System) |
|---|---|
| Call smitt | |
| | Which of these do you mean? There are three |
| | entries that sound like that. |
| | Jenny Smith? |
| No | |
| | Johhny Smith? |
| No. | |
| | Freddie Smitt? |
| Yes. | |

A second exemplary narrowing is shown below.

| (User) | (System) |
|---|---|
| Call smith | |
| | Which Smith do you mean? There are two. |
| Johnny. | |

In either case, the VoIP server 200 can terminate its collection of voice signals and then utilize the call control services to complete the requested call (by receiving from the phonebook service the corresponding number), just as if it had received the number to be dialed from the voice device as the initial dialing sequence. (In the case of remote voice command services, the VoIP server would receive from the remote command services a number (or a list of numbers) to call and connect on behalf of the extension associated with the received voice.)

While the above discussion has been provided in the context of the voice device establishing a voice connection with the VoIP server 200 such that the VoIP server 200 then passes the voice signals to a speech recognition platform 210, in an alternate embodiment, the voice devices are enhanced to support the voice services. In such a configuration, when the voice device requests voice services, the VoIP server 200 initially communicates with the speech recognition platform 210 to determine (1) one or more port numbers to which the voice device can connect directly with the speech recognition platform 210 and (2) how the results of the speech recognition are to be returned to the VoIP server 200. For example, the VoIP server 200 may negotiate with the speech recognition platform 210 that a new “transaction” is to occur and that the transaction is to be given transaction identifier “0x12345.” When the voice device connects to the speech recognition platform 210 at the port specified by the VoIP server 200, the voice device passes the transaction identifier to the speech recognition platform 210. The voice device then passes the voice data to the speech recognition platform 210, either at the same port or at a port associated with the transaction identifier. When the speech recognition platform 210 finishes detecting the speech, it stops processing voice signals over the connection with the voice device and returns the corresponding text to the VoIP server 200 along with the transaction identifier. Such configurations are helpful to avoid the VoIP server 200 becoming a bandwidth bottleneck for communications.

While the above discussion has been provided in the context of a single speech recognition platform 210 performing all of the speech-to-text conversion, other embodiments are possible where the number of platforms 210 that are used can be changed dynamically due to load. In addition, when the voice device is going to make a connection to the platform 210 directly, the VoIP server 200 preferably determines the closest and/or least congested platform 210 that the voice device can use and routes the connection request there so that the voice device connects with the closest and/or least congested platform 210. The platform 210 to which a user's speech is sent further may be selected using historical information on which such platform 210 previously provided on average the highest confidence result for a known user's speech.

Since the VoIP server 200 knows which user is requesting voice services (based on the extension that is calling or some other authentication mechanism), the VoIP server 200 may direct to user's speech to a platform configured to take into consideration a user's speech patterns and/or accent. Likewise, a user may be able to train a platform 210 with a user's speech and then be directed to that platform for future services. As discussed above, this further allows services to be configured or tailored to a particular user. For example, when looking up information on contacts or calendars, the user identification is used to index the corresponding data (or filter results). As discussed above, individual users can be identified in a number of ways, including, but not limited to, an extension, an extension and PIN, a DTMF sequence, a globally unique id (GUID), an “app” ID associated with a virtual telephone, a voiceprint (e.g., of a known standard phrase or of a secret passphrase), a browser-like “cookie,” a caller ID and VoIP server ID combination, or any combination thereof.

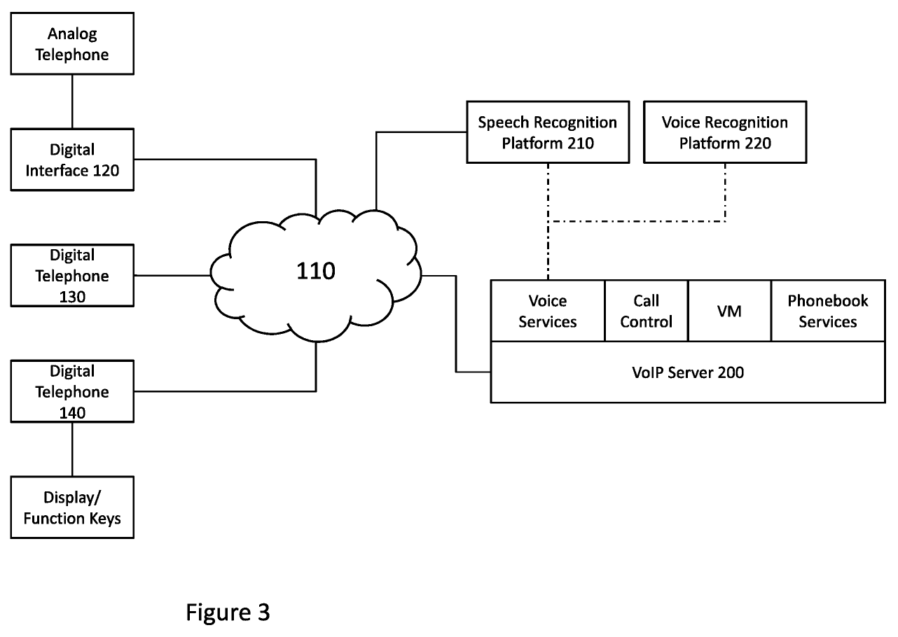

As shown in FIG. 3, instead of only using one or more speech recognition platforms 210, the system may also utilize one or more voice recognition platforms 220. In such a configuration, at least one voice recognition platform 220 is provided with training data to enable it to distinguish voices from each other. For example, all of the voices that utilize a particular VoIP server 200 may be used to train the voice recognition platform 220. In such a configuration, a first user in the office of a second user may still be able to utilize voice services by calling a number common to both users because the system will determine which user is speaking in addition to what was said. Similarly, a user using a common phone (e.g., in a conference room) may utilize his/her voice services. (As a further level of control, to distinguish users, each user may be given a different extension to dial to get voice services, or each user may a common or user-specific extension along with any of the user authentication/identification mechanisms discussed above.) In systems capable of distinguishing users from each other, voice commands can therefore be tailored to the recognized user. For example, when a first user is in a second user's office and dials the voice services extension, using voice recognition, a user can get the voicemail for the first user instead of the second user simply by saying “Hey Voicebot . . . check my voicemail.” Because the system recognizes who the speaker is, the system knows whose voicemail information to request.

While the above discussion has been provided in the context of a VoIP device going “off-hook” to obtain the enhanced services described herein, the system need not operate as if the user is off-hook for many other purposes. Indeed, the system need only create a communications channel between the VoIP device and the VoIP server and leave it open for the duration during which the user is obtaining the voice-based services. For all other purposes, the VoIP device can appear to be “on-hook” even while connected to voice services with the VoIP server. This is advantageous, for example, when a secretary is monitoring whether his/her boss is on the phone so that the secretary knows when he/she can go into the boss' office without disrupting a call.

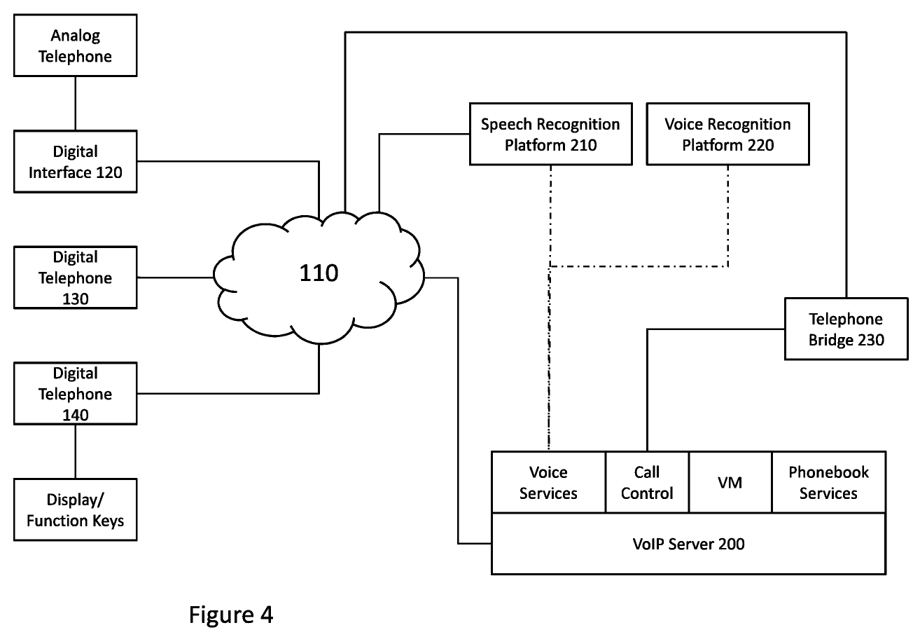

As shown in FIG. 4, it is possible to utilize telephone bridge services in accordance with the voice commands described herein. For example, the user may initially call the voice services platform and then request that a number of people be added to a conference call by using voice services and stating “Hey Voicebot: . . . set up a conference call with Zali and Jenny Smith.” The system would then perform the telephone number lookups as described above but rather than dialing a single callee, the VoIP server 200 would stop providing voice services and control a bridge to call all requested participants. Alternatively, voice services could provide services (as described herein) later during the conference call by being reactivated (e.g., either using a key phrase when in quiet mode or by dialing a feature code during the call).

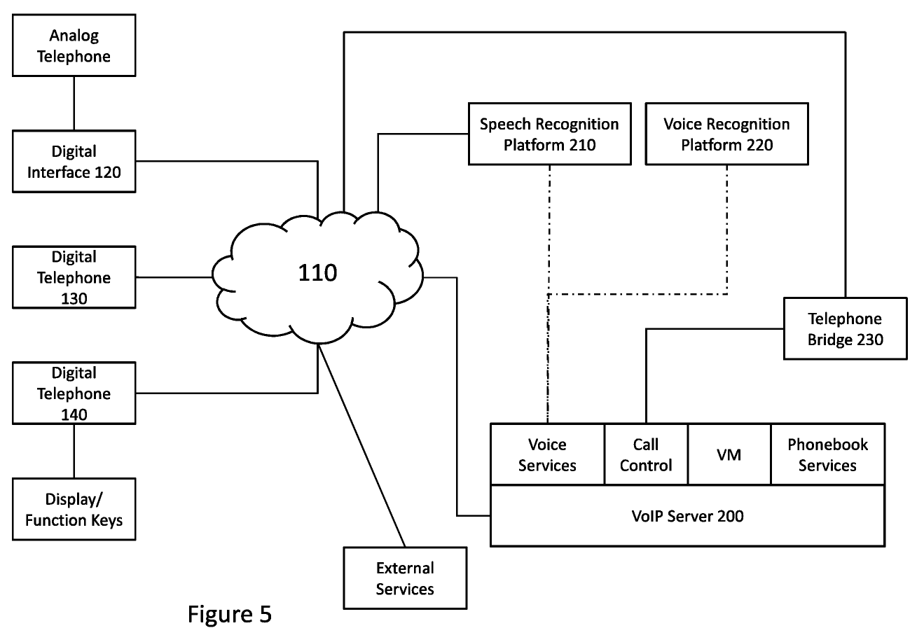

As shown in FIG. 5, external services also can be utilized to provide query functions and/or control using third-party application programming interfaces (APIs). For example, external calendaring and contact services could be utilized to coordinate meetings using voice commands. In one such use case, a user may utilize voice services and state “Schedule an appointment with Jane Doe for Monday at 10 am.” If Jane Doe's phone number is not in the company directory, configured external services may be utilized to supplement the phone number/calendar search. For example, the VoIP server 200 may integrate with Google Contact and/or Google Calendar (or other similar services). The VoIP server 200 may detect that there is a conflict at that time and suggest alternate times. Upon finding an acceptable time, the VoIP server 200 can send out external source-specific invites so that the meeting can be accepted (or declined) by the participants. In addition, for meetings that require peoples' physical presence, voice services can inform a scheduling user of possible meeting locations and automatically request a room reservation when a location is selected. For example, having determined that conference rooms 1 and 2 were both available at the mutually convenient time for the participants, voice services would suggest both to the user (using voice prompts) and send a room request to the scheduling service (or coordinator) to ensure the room reservation after one was selected. The location, therefore, could be included automatically on the meeting invitation.

In addition, because user-specific (or group-/company-specific) information can be configured with the system described herein, a user also can ask voice services to “Order the usual food for the meeting.” By looking up the time of the meeting as well as any dietary restrictions that the speaker and other participants have (including date-specific dietary restrictions for religious holidays/events such as for Passover or Lent), the proper food (and drinks) can be ordered automatically for the meeting.

Other external services include, but are not limited to, checking weather, booking travel, and taking notes. Voice services can also be used to send text or SMS messages to a list of recipients.

Similarly, external services may provide access to connected Internet of Things (IoT) devices such as thermostats, lights and other home appliances. Such a system can be used to control home automation functions using voice commands.

In an additional alternate embodiment, rather than the VoIP server 200 disconnecting itself once it determines who it is supposed to call, the VoIP server 200 instead may continue to be active in order to provide voice services during a call. For example, having used voice services to call “Jenny Smith,” a user and Jenny agree during their call that they want to schedule a follow-up meeting. Rather than each person trying to then look at their respective calendars to find an appropriate time, the user may instead ask voice services to schedule it for them. For example, during the call, voice services detects that it is being addressed when the voice device or VoIP server 200 detects a particular DTMF code or function key being pressed or when speech recognition platform 210 (which in this embodiment has been getting the whole conversation) detects “Hey Voicebot.” The subsequent voice data is then transmitted to the speech recognition platform 210 for processing and the text is returned to VoIP server 200, as described above. Any interactions that the voice services needs to have with the user can then be performed as described above without disconnecting the voice call with the callee (e.g., Jenny Smith). Voice services similarly can be used to add one or more additional callees during a call, potentially utilizing the bridge access as described above. Similarly, when voice services stays connected during a call, voice services can be used to control an in-progress call in other ways (e.g., request the voice services to “hang up” when someone's voicemail answers).

According to another aspect of the enhanced VoIP server 200 described herein, the voice services may also interact with a user on an incoming basis as well. For example, while the user is using voice services to listen to voicemail or set up a meeting, VoIP server 200 knows that the user's line isn't really occupied with an incoming or outgoing request—it is just using voice services. Thus, the VoIP server 200 need not cause the user's line to ring busy when the user is using voice services. Instead, the voice device can play a ring tone to announce an incoming call, per usual, such that the user may disconnect from voice services to answer the call (e.g., by hanging up). Alternatively, voice services could play a message indicating that there is an incoming call. Voice services can even be configured to look up the caller using phonebook services and announce who the caller is and wait for a voice-based answer such as “answer,” “ignore” or “send to voicemail.” In such configurations where the user's phone does not ring busy while using voice services, a user may indeed stay connected to voice services throughout the day to receive the benefit of the voice services without having to dial the corresponding extension before each set of commands.

In addition to utilizing the techniques described herein with respect to a VoIP server, a voice services platform also could be added to existing conference bridges such that voice services can be provided to uniquely identifiable users (e.g., using a “conference coordinator code”) using any kind of phone (and not just a VoIP device). Just as a conference coordinator calls a bridge and then could dial a feature code (e.g., “**”) to indicate that a participant should be added or dropped, the conference coordinator could instead dial a voice services feature code (e.g., “*88”) and then utilize any of the services described herein

As would be appreciated by those of ordinary skill in the art, the VoIP servers described herein can be implemented as computers running software for performing the functions described herein. The software can be any one or a combination of executable code and interpreted code for performing the functions described herein (e.g., connecting with the VoIP device, receiving the voice signals, forwarding the voice signals to a voice/speech recognition platform), and receiving the corresponding detected command). The server can be provided with a single core processor or a multi-core processor, and each may be single threaded or multi-threaded, and each may be capable of performing parallel operations (e.g., Single Instruction Multiple Data (SIMD) or Multiple Instruction Multiple Data (MIMD)).

While certain configurations of structures have been illustrated for the purposes of presenting the basic structures of the present invention, one of ordinary skill in the art will appreciate that other variations are possible which would still fall within the scope of the appended claims.

1. A method of providing voice services to using at least one voice over IP (VoIP) device using a VoIP server, the VoIP server performing the method comprising:
receiving a connection from the at least one VoIP device;
receiving an indication that the VoIP server is to provide voice services to the at least one VoIP device;
receiving digital voice signals from the at least one VoIP device;
determining a voice command from the received digital voice signals; and
responding to the voice command.

2. The method as claimed in claim 1, wherein the at least one VoIP device comprises a portable device running an app.

3. The method as claimed in claim 1, wherein the at least one VoIP device comprises a portable telephone device running an iOS app.

4. The method as claimed in claim 1, wherein the at least one VoIP device comprises a portable telephone device running an Andriod app.

5. The method as claimed in claim 1, wherein the at least one VoIP device comprises a VoIP telephone having a handset.

6. The method as claimed in claim 1, wherein receiving the indication that the VoIP server is to provide voice services to the at least one VoIP device comprises receiving at least one of a preconfigured number and a feature code.

7. The method as claimed in claim 1, wherein receiving the digital voice signals from the at least one VoIP device comprises receiving the digital voice signals from the at least one VoIP device in encrypted form.

8. The method as claimed in claim 1, wherein receiving the digital voice signals from the at least one VoIP device comprises receiving the digital voice signals from the at least one VoIP device in unencrypted form.

9. The method as claimed in claim 1, wherein determining the voice command from the received digital voice signals comprises:
sending the received digital voice signals to a speech recognition platform separate from the VoIP server; and
receiving the voice command from the speech recognition platform.

10. The method as claimed in claim 1, wherein determining the voice command from the received digital voice signals comprises:
sending the received digital voice signals to a voice recognition platform separate from the VoIP server; and
receiving the voice command from the voice recognition platform.

11. The method as claimed in claim 1, wherein responding to the voice command comprises at least one of a phone number look up command, a redial command, a call forwarding command, and a call bridging command.

12. The method as claimed in claim 1, wherein determining the voice command from the received digital voice signals comprises:
sending the received digital voice signals to a speech recognition platform until the speech recognition platform requests that the VoIP server stop sending received digital voice signals; and
receiving the voice command from the speech recognition platform.

13. The method as claimed in claim 1,
wherein receiving digital voice signals from the at least one VoIP device comprises receiving digital voice signals from the at least one VoIP device for a fixed period of time; and
wherein determining the voice command from the received digital voice signals comprises:
sending, to a speech recognition platform, the received digital voice signals that were received from the at least one VoIP device during the fixed period of time; and
receiving the voice command from the speech recognition platform.

14. The method as claimed in claim 1,
wherein receiving digital voice signals from the at least one VoIP device comprises receiving digital voice signals from the at least one VoIP device until at least one of a button press and a DTMF tone is detected; and
wherein determining the voice command from the received digital voice signals comprises:
sending, to a speech recognition platform, the received digital voice signals that were received from the at least one VoIP device until the at least one of the button press and the DTMF tone is detected; and
receiving the voice command from the speech recognition platform.

15. The method as claimed in claim 1,
wherein receiving digital voice signals from the at least one VoIP device comprises receiving digital voice signals from the at least one VoIP device until a silence period is detected for a threshold period of time; and
wherein determining the voice command from the received digital voice signals comprises:
sending, to a speech recognition platform, the received digital voice signals that were received from the at least one VoIP device until the silence period is detected for the threshold period of time; and
receiving the voice command from the speech recognition platform.

16. A voice over IP (VoIP) server for providing voice services to at least one VoIP device, the VoIP server comprising:
a computer processor; and
computer memory for storing computer instructions for causing the computer processor when executing the computer instructions to control the VoIP server to:
receive a connection from the at least one VoIP device;
receive an indication that the VoIP server is to provide voice services to the at least one VoIP device;
receive digital voice signals from the at least one VoIP device;
determine a voice command from the received digital voice signals; and
respond to the voice command.

17. The VoIP server as claimed in claim 16, wherein the digital voice signals from the at least one VoIP device comprises digital voice signals in encrypted form.

18. The VoIP server as claimed in claim 16, wherein the digital voice signals from the at least one VoIP device comprises digital voice signals in encrypted form.
